(19) United States
(12) Patent Application Publication
(10) Pub. No.: US 2026/0288325 A1
(43) Pub. Date: Sep. 24, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: MIZUKI MATSUBARA, München (DE)

(21) Appl. No.: 19/567,899

(22) Filed: Mar. 16, 2026

(30) Foreign Application Priority Data
Mar. 21, 2025 (JP) 2025-046637

(51) Int. Cl. G06F 3/0486; G06F 3/04817

(52) U.S. Cl. CPC G06F 3/0486; G06F 3/04817

(57) ABSTRACT

An information processing apparatus which generates an image to be displayed on an eyewear-type display unit includes a reception unit which receives external data which a second information processing apparatus retains, a generation unit which generates a virtual display for displaying an object corresponding to the external data on the display unit, a range acquisition unit which acquires a display range of the virtual display in the display unit, an instruction unit which generates instruction information for the second information processing apparatus, and a transmission unit which transmits the instruction information to the second information processing apparatus, wherein, in a case where a user input for dragging the object to outside the display range has been acquired, the instruction unit generates, as the instruction information, processing which the second information processing apparatus is caused to perform depending on a position to which the object has been dragged.

### BACKGROUND

### Field of the Technology

The present disclosure relates to an information processing apparatus, an information processing method, and a storage medium.

### Description of the Related Art

In recent years, a user interface (UI) configured in such a manner that the screen of a personal computer (PC) is displayed within the screen of an eyewear-type display device as a virtual display and the user operates the PC via an operation on the virtual display has been becoming widespread. For example, displaying, within the virtual display, an application window for, for example, office work which runs on the PC enables a user wearing the eyewear-type display device to perform, for example, office work. Moreover, since, as viewed from the user of the eyewear-type display device, the virtual display is able to display the application window in a larger scale than the actual PC screen, the user is enabled to perform, for example, office work on such a large-screen virtual display.

Japanese Patent Application Laid-Open No. 2018-120598 describes a technique which enables the user to, for example, drag and drop a virtual object, which is being displayed within the screen of a head-mounted display (HMD), onto a three-dimensional (3D) printer, which is also being displayed within the screen of the HMD, thus printing the virtual object. According to the technique described in Japanese Patent Application Laid-Open No. 2018-120598, it is possible to achieve an intuitive UI for the user in such a way as to drag and drop a virtual object in the screen of the HMD.

### SUMMARY

According to embodiments of the present disclosure, an information processing apparatus configured to generate an image to be displayed on an eyewear-type display unit includes a reception unit configured to receive external data which a second information processing apparatus different from the information processing apparatus retains from the second information processing apparatus, a generation unit configured to generate a virtual display for displaying an object corresponding to the external data on the display unit, a range acquisition unit configured to acquire a display range of the virtual display in the display unit, an input unit configured to acquire a user input, an instruction unit configured to generate instruction information for the second information processing apparatus, and a transmission unit configured to transmit the instruction information to the second information processing apparatus, wherein, in a case where the user input for dragging the object to outside the display range has been acquired, the instruction unit generates, as the instruction information, processing which the second information processing apparatus is caused to perform depending on a position to which the object has been dragged.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram illustrating a display example of a display screen of a head-mounted display (HMD).

FIG. 1B is a diagram illustrating a display example of a virtual display.

FIG. 2 is a diagram illustrating an example of a usage situation of the HMD.

FIG. 3 is a diagram illustrating a configuration example of hardware of an information processing apparatus.

FIG. 4 is a diagram illustrating a functional configuration example of each equipment such as the information processing apparatus.

FIG. 5A is a diagram illustrating an image coordinate system.

FIG. 5B is a diagram illustrating a three-dimensional coordinate system.

FIG. 6 is a diagram illustrating a manner of dragging application data.

FIG. 7 is a flowchart illustrating information processing according to a first embodiment.

FIG. 8 is a flowchart illustrating processing which is performed at the time of start of drag.

FIG. 9 is a flowchart illustrating processing which is performed at the time of drag in progress.

FIG. 10 is a flowchart illustrating processing which is performed at the time of drop in the first embodiment.

FIG. 11A is a diagram illustrating a display screen example of an HMD in a second embodiment.

FIG. 11B is a diagram illustrating a display screen example of the HMD in the second embodiment.

FIG. 12 is a diagram illustrating a data flow in the second embodiment.

FIG. 13 is a flowchart illustrating processing which is performed at the time of drop in the second embodiment.

FIG. 14 is a diagram illustrating a data flow in a first modification example.

FIG. 15 is a diagram illustrating a data flow in a second modification example.

FIG. 16 is a diagram illustrating a data flow in a third modification example.

FIG. 17A is a diagram illustrating a display screen example of an HMD in a third embodiment.

FIG. 17B is a diagram illustrating a display screen example of the HMD in the third embodiment.

FIG. 18 is a flowchart illustrating processing which is performed at the time of drop in the third embodiment.

### DESCRIPTION OF THE EMBODIMENTS

Some conventional techniques achieve a user interface (UI) for operating a virtual object within the screen of a head-mounted display (HMD) but are not able to, for example, drag an application window, which is being displayed within a virtual display, to outside a display range of the virtual display. Thus, since such conventional techniques are not able to, for example, drag an application window, which runs on a personal computer (PC), to outside a display range of the virtual display, embodiments of the present disclosure are directed to enabling a user of the HMD to perform an operation that can be called intuitive.

Various embodiments, features, and aspects of the present disclosure will be described in detail below with reference to the drawings. The following embodiments are not intended to limit the present disclosure, and, moreover, not all of the combinations of features described in the embodiments are not necessarily essential for solutions in the present disclosure. Configurations of the embodiments can be modified or altered as appropriate depending on specifications of apparatuses to which the present disclosure is applied or various conditions (for example, use conditions and usage environments). Moreover, some of the respective embodiments and modification examples described below can be configured to be combined with each other as appropriate. In the following respective embodiments, any duplicate descriptions of the same hardware configurations or functional configurations and the same processing processes (processing steps) are omitted.

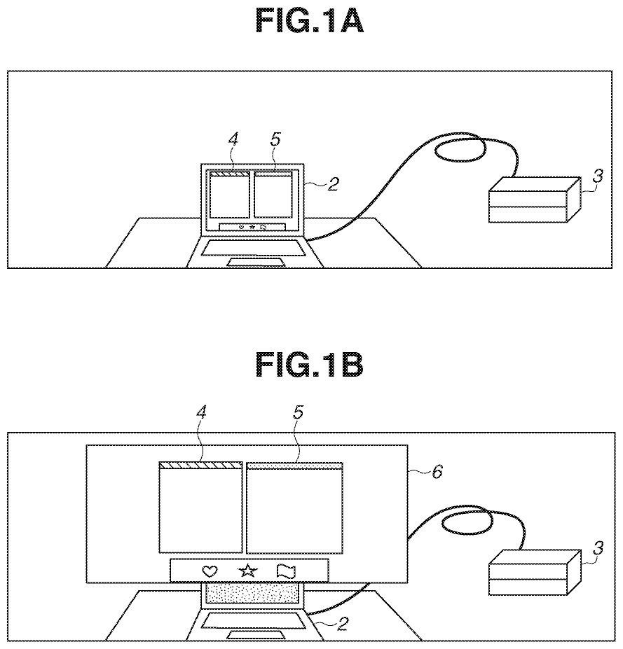

FIGS. 1A and 1B are diagrams each illustrating an example of a display screen of a head-mounted display (HMD), which is an example of an information processing apparatus equipped with an eyewear-type display device. Furthermore, while, in the present embodiment, the HMD is assumed to be a video see-through type HMD, but can be an optical see-through type HMD.

FIG. 1A illustrates a screen example obtained before the video see-through type HMD displays a virtual display. For example, on a screen of the video see-through type HMD, a video image obtained by an image capturing unit mounted in the HMD performing image capturing of, for example, a personal computer (PC) 2 in real space, a printer 3, which is also a device in real space, and the top board of a desk and a cable in real space is displayed. Furthermore, in the present embodiment, the PC 2 is taken as an example of a second information processing apparatus different from the information processing apparatus equipped with an eyewear-type display device. Moreover, it is assumed that, on the PC 2, for example, two application programs (hereinafter referred to as “applications”) are being activated and, on the screen of the PC 2, two application windows 4 and 5 corresponding to the two applications are being displayed.

FIG. 1B illustrates a screen example obtained in a case where the video see-through type HMD is displaying the screen of the PC 2 as a virtual display 6 within the screen of the HMD. In a case where a virtual display has been activated in the video see-through type HMD, the HMD displays the virtual display 6 in superimposition on a captured image in real space acquired by the image capturing unit. In the example illustrated in FIG. 1B, it is assumed that the virtual display 6 is being displayed in such a way as to have a display size larger than the physical screen size of a display mounted in the PC 2. The virtual display 6 can be set to a display size larger than the display of the PC 2 and, therefore, can be displayed in a size larger than that of each application window on the display of the PC 2. In the case of the example illustrated in FIG. 1B, two application windows 4 and 5 corresponding to the two applications running on the PC 2 are being displayed on the virtual display 6.

### First Embodiment

In the first embodiment, an example of achievement of a user interface (UI) which enables the user to drag and drop an application window corresponding to an application running on the PC 2 to outside a display range of the virtual display 6 is described. Furthermore, in the first embodiment, dragging and dropping an application window to outside a display range of the virtual display 6 refers to dragging and dropping application data which is being handled by an application window running on the PC 2. In the first embodiment, as examples of an application running on the PC 2, various applications such as a Portable Document Format (PDF) viewer, a video viewer, and a presentation material creation application are supposed. The application window 5 on the virtual display 6 illustrated in FIG. 1B is assumed to be, for example, an application window of the PDF viewer. Then, in the first embodiment, for example, a UI for such a case where the user drags the application window 5 to outside a display range of the virtual display 6 is described. Although details are described below, in the case of dragging the application window 5 to outside a display range of the virtual display 6, the HMD generates an image for drag representing application data about the application window 5. Then, the HMD implements a UI which enables the user to drag the image for drag to outside a display range of the virtual display 6.

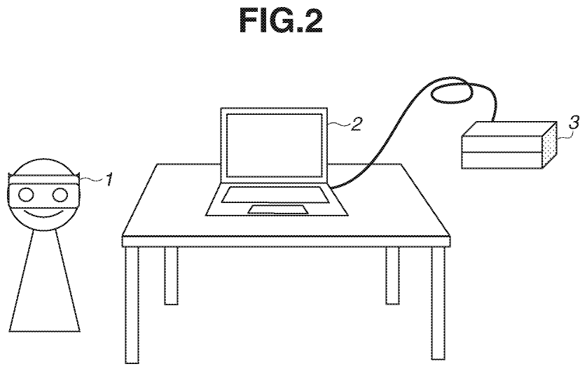

FIG. 2 is a conceptual diagram illustrating an example of a situation in which the user is using an HMD 1.

FIG. 2 illustrates a configuration example which is composed of, for example, the HMD 1, which is a video see-through type and eyewear-type information processing apparatus, the PC 2 in real space, the printer 3, which is also a device in real space, and the table and cable. The user is assumed to be looking at a displayed image such as that illustrated in FIG. 1A or 1B through the screen of the HMD 1.

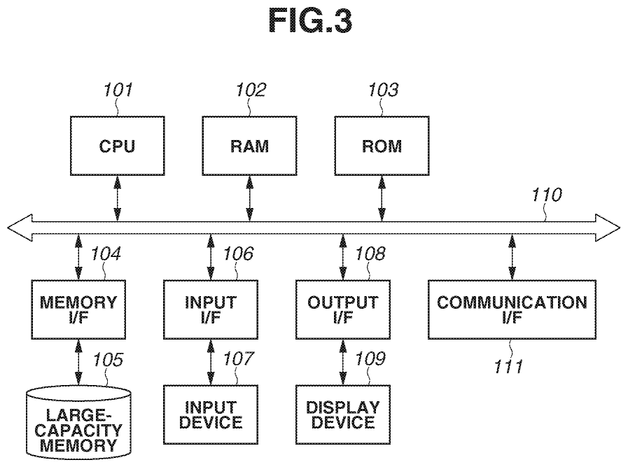

FIG. 3 is a diagram illustrating an example of an internal hardware configuration included in the eyewear-type HMD 1, which is an example of an information processing apparatus according to the first embodiment. Furthermore, FIG. 3 illustrates only principal constituent elements included in the HMD 1.

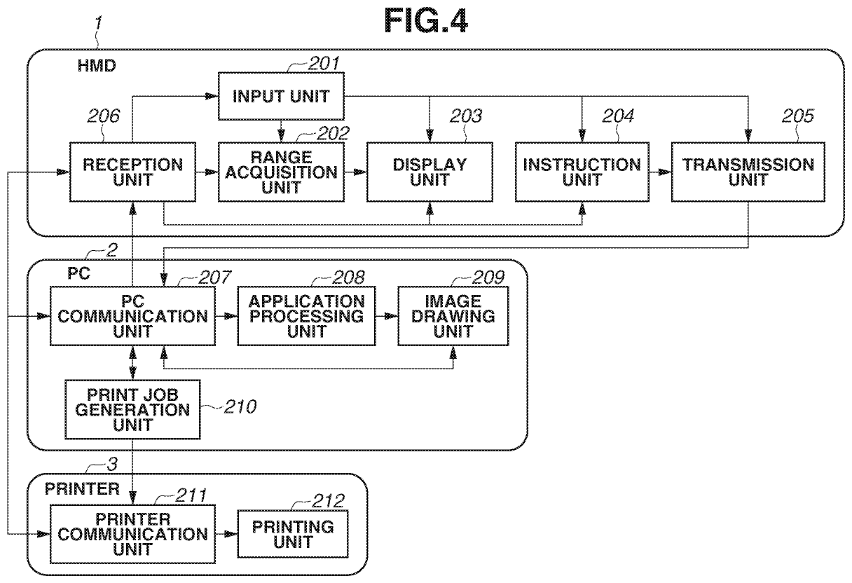

Referring to FIG. 3, a central processing unit (CPU) 101 controls operations of the respective constituent elements interconnected via a system bus 110, by using a random access memory (RAM) 102 as a work memory and executing a control program stored in, for example, a read-only memory (ROM) 103. Moreover, the CPU 101 performs data readout from a large-capacity memory 105 via a memory interface (I/F) 104 and performs data writing to the large-capacity memory 105 via the memory I/F 104. Additionally, the CPU 101 loads an information processing program according to the first embodiment stored in the large-capacity memory 105 onto the RAM 102 and executes the program loaded on the RAM 102, thus implementing operations of the respective functional units corresponding to a functional configuration illustrated in FIG. 4 described below.

The memory interface (hereinafter, “interface” being referred to as “I/F”) 104 is connected to the large-capacity memory 105. The memory I/F 104 is an I/F of, for example, Serial AT Attachment (SATA) or Peripheral Component Interconnect Express (PCIe).

An input I/F 106 is connected to an input device 107 which includes, for example, buttons and keys mounted in the HMD 1, an image capturing unit such as a red-green-blue (RGB) camera, an acceleration sensor, and an angular velocity sensor. The input I/F 106 can be a serial bus I/F such as a Universal Serial Bus (USB) bus or IEEE 1394 bus. The CPU 101 is able to read in data from the input device 107 via the input I/F 106.

The video see-through type HMD 1 taken as an example in the first embodiment includes, to implement HMD position tracking by the Inside-Out method, for example, a plurality of RGB cameras, an acceleration sensor, and an angular velocity sensor as the input device 107. Moreover, the input device 107 also includes a depth sensor such as Light Detection And Ranging (Lidar) which is capable of acquiring a distance between the HMD and a real object.

An output I/F 108 is connected to a display device 109, which is a display of the HMD 1.

The output I/F 108 can be a video output I/F such as Digital Visual Interface (DVI) or High-Definition Multimedia Interface (HDMI®). The CPU 101 outputs, for example, an image captured by the RGB cameras or an image in the virtual display to the display device 109 via the output I/F 108.

The display device 109 includes a left-eye display and a right-eye display, each of which is composed of a displaying panel such as a liquid crystal display or an organic electroluminescent (EL) display. Moreover, a left-eye eyepiece lens is provided in front of the left-eye display of the display device 109, and a right-eye eyepiece lens is provided in front of the right-eye display of the display device 109. In a case where the user has worn the HMD 1, the left-eye eyepiece lens is located in front of the left eye of the user and the right-eye eyepiece lens is located in front of the right eye of the user. Then, the CPU 101 generates a left-eye displaying image and a right-eye displaying image, and causes the left-eye display to display the left-eye displaying image and causes the right-eye display to display the right-eye displaying image. This causes the user to look at an enlarged virtual image of the left-eye displaying image displayed on the left-eye display via the left-eye eyepiece lens and look at an enlarged virtual image of the right-eye displaying image displayed on the right-eye display via the right-eye eyepiece lens. Moreover, since an appropriate parallax is provided between the left-eye displaying image and the right-eye displaying image, the user is able to obtain a visual perception having a sense of depth.

A communication I/F 111 connects to, for example, the PC 2, the printer 3, and cloud computing described below. The communication I/F 111 is an I/F for, for example, Bluetooth®, Wi-Fi®, or a wired local area network (LAN). The CPU 101 is able to store, in, for example, the large-capacity memory 105, data transmitted from, for example, the PC 2, the printer 3, or the cloud computing via the communication I/F 111. Moreover, the CPU 101 is able to transmit data stored in the large-capacity memory 105 to, for example, the PC 2, the printer 3, or the cloud computing via the communication I/F 111.

Furthermore, although, in addition to the above-mentioned constituent elements, the hardware configuration of the information processing apparatus includes other constituent elements, such other constituent elements are omitted from description here.

FIG. 4 is a functional block diagram illustrating a functional configuration of the HMD 1, which is an information processing apparatus according to the first embodiment, a functional configuration of the PC 2, which is a second information processing apparatus according to the first embodiment, and a functional configuration of the printer 3.

Frist, the functional configuration of the HMD 1 is described. The functional configurations of the PC 2 and the printer 3 are described below.

The HMD 1 includes, as illustrated in FIG. 4, an input unit 201, a range acquisition unit 202, a display unit 203, an instruction unit 204, a transmission unit 205, and a reception unit 206. The HMD 1 is connecting to the PC 2 and the printer 3. Furthermore, while the HMD 1 includes, in addition to the functional units illustrated in FIG. 4, for example, an image capturing unit and various sensor units including an acceleration sensor, angular velocity sensor, and a depth sensor, the illustration and description thereof are omitted.

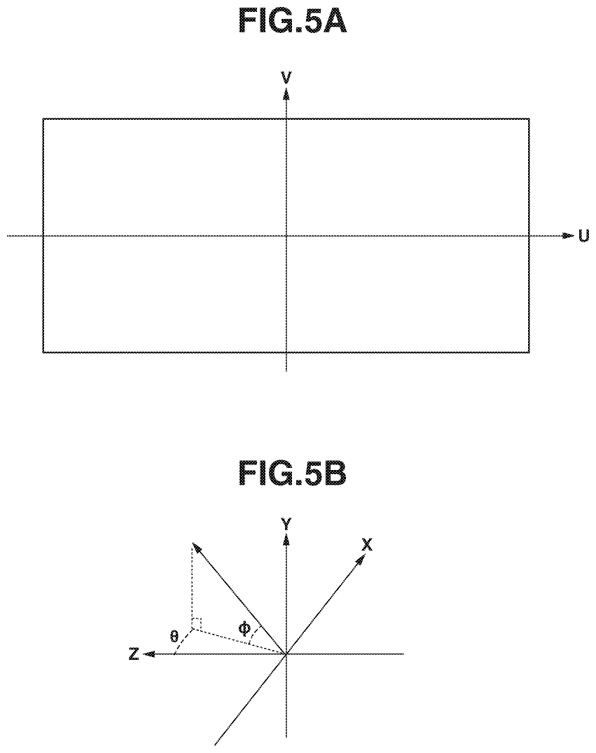

Moreover, FIG. 5A is a diagram illustrating a coordinate system of an image captured by the RGB camera of the HMD 1. The image coordinate system illustrated in FIG. 5A is a UV coordinate system in which the horizontal direction is set to U-axis, the vertical direction is set to V-axis, and the center of an image is set to an origin. FIG. 5B is a diagram illustrating a three-dimensional coordinate system with the HMD 1 set as the center in a real space in which the HMD 1 exists. The three-dimensional coordinate system is an XYZ coordinate system in which the front direction of the HMD 1 is set to Z-axis, the horizontal direction thereof is set to X-axis, and the vertical direction thereof is set to Y-axis. Moreover, in the three-dimensional coordinate system, the angle θ is an angle formed on the XZ plane and the angle φ is an angle formed on the YZ plane.

The input unit 201 of the HMD 1 acquires an input from the user of the HMD 1 based on moving image data captured by the RGB camera and depth data detected by the depth sensor. In the case of the first embodiment, the input unit 201 acquires a user input based on a result of recognizing a hand gesture from a moving image obtained by the RGB camera performing image capturing of the hand of the user and depth data detected by the depth sensor (data representing a distance from the HMD 1 to the hand of the user in the depth direction).

The input unit 201 detects an action which brings, for example, the middle finger and thumb of the hand of the user into contact with each other from a moving image obtained by the RGB camera performing image capturing of one hand of the user and, in a case where, after the position of the hand has moved in such a state, an action which separates the middle finger and thumb from each other has been performed, the input unit 201 recognizes that a drag-and-drop operation has been performed. More specifically, when having detected an action which brings the middle finger and thumb of the hand into contact with each other from the captured moving image of the hand, the input unit 201 acquires UV coordinates of the fingertips obtained in a state in which the middle finger and thumb are in contact with each other and depth data in the depth direction from the HMD 1 to the hand detected by the depth sensor. Then, the input unit 201 outputs, to the display unit 203 and the transmission unit 205, coordinates represented by the UV coordinates (Udrag, Vdrag) of the fingertips obtained at that time and depth data Ddrag as drag coordinates (Udrag, Vdrag, Ddrag) obtained at the time of drag operation. Furthermore, in a case where, for example, the position of the hand has moved in a state in which the middle finger and thumb are in contact with each other, the input unit 201 acquires the drag coordinates (Udrag, Vdrag, Ddrag) corresponding to that move and outputs the acquired drag coordinates (Udrag, Vdrag, Ddrag) to the display unit 203 and the transmission unit 205. Moreover, in a case where, after the position of the hand has moved in a state in which the middle finger and thumb are in contact with each other, an action which separates the middle finger and thumb from each other has been performed, the input unit 201 acquires the UV coordinates of the hand on an image obtained when the middle finger and thumb have been separated from each other and depth data which the depth sensor has detected about the hand at that time. Then, the input unit 201 outputs, to the instruction unit 204, the UV coordinates (Udrop, Vdrop) of the hand obtained at that time and the coordinates represented by the depth data Ddrop, as post-drag drop coordinates (Udrop, Vdrop, Ddrop).

The range acquisition unit 202 acquires a display range of the virtual display 6. In the case of the first embodiment, the position of the virtual display 6 is assumed to be predefined. The range acquisition unit 202 acquires information (Uvd, Vvd, Wvd, Hvd) composed of central coordinates (Uvd, Vvd) of the virtual display 6 and a width Wvd and a height Hvd of the virtual display 6 as display range information about the virtual display 6. Then, the range acquisition unit 202 outputs the display range information (Uvd, Vvd, Wvd, Hvd) about the virtual display 6 to the display unit 203 and the transmission unit 205.

The display unit 203 generates an image for drag based on the drag coordinates (Udrag, Vdrag, Ddrag) transmitted from the input unit 201, and displays the generated image for drag on the display of the HMD 1. Furthermore, the image for drag is assumed to be an icon image representing the type of an application of the application window on the virtual display 6. Moreover, in a case where the display unit 203 has acquired, via the reception unit 206, display data which the PC 2 retains and which is displayed on a screen thereof described below as external data, the display unit 203 displays a virtual display for displaying the acquired display data on the display of the HMD 1.

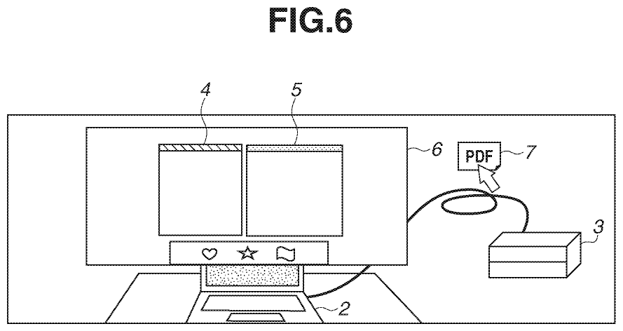

FIG. 6 is a diagram illustrating a display screen example of the HMD 1 obtained when the application window 5 of the PDF viewer has been dragged to the vicinity of the printer 3, which is outside the display range of the virtual display 6. In a case where, as illustrated in FIG. 6, the user has dragged the application window 5 of the PDF viewer to outside the display range of the virtual display 6, an image for drag 7 representing the application of the PDF viewer is generated and the generated image for drag 7 moves within the screen according to the drag operation. Furthermore, while, in the above description, the application window is taken as an example for description, the thing to be dragged is not limited to a window but can be an object such as an icon representing the above-mentioned external data.

The instruction unit 204 generates, based on the drag coordinates (Udrag, Vdrag, Ddrag) and drop coordinates (Udrop, Vdrop, Ddrop) obtained by the user input, instruction information for processing which the PC 2 performs with respect to a device present near the drop coordinates. For example, suppose a case where an operation which drags the application window 5 to outside the display range of the virtual display 6 has been performed and the device present near the drop coordinates is the printer 3. In this case, the instruction unit 204 generates print instruction information for the PC 2 to cause the printer 3 to perform printing and outputs the generated print instruction information to the transmission unit 205.

The transmission unit 205 transmits, to the PC 2, the drag coordinates (Udrag, Vdrag, Ddrag) which the input unit 201 has generated according to the user input, the information (Uvd, Vvd, Wvd, Hvd) which represents the display range of the virtual display 6, and the instruction information which the instruction unit 204 has generated.

The reception unit 206 receives data from the printer 3 and the PC 2 via wireless communication or wired communication. In the case of the first embodiment, the reception unit 206 acquires, from the PC 2, display data to be displayed on the virtual display 6, and outputs data that is based on the display data to the display unit 203.

Moreover, the reception unit 206 receives, from the PC 2, an application name corresponding to the application window 5 on which the user is performing a drag operation, and outputs the received application name to the instruction unit 204. In the case of the first embodiment, the application name of the application window 5 is, for example, an application name indicating the PDF viewer.

Moreover, the reception unit 206 acquires a distance and angles between the HMD 1 and the printer 3 as position information representing a positional relationship between the printer 3 and the HMD 1.

The reception unit 206 acquires a distance d between the HMD 1 and the printer 3 with use of, for example, High Accuracy Distance Measurement (HADM) using Bluetooth. Moreover, the reception unit 206 acquires angles between the HMD 1 and the real printer 3 in the above-mentioned three-dimensional coordinate system with the HMD 1 set as the center thereof illustrated in FIG. 5B with use of a Bluetooth communication. Therefore, it is assumed that pairing has been preliminarily performed between the reception unit 206 and the printer 3 by a known pairing technique. The reception unit 206 acquires the values of angles (θreal, φreal) of the printer 3 represented by the three-dimensional coordinate system illustrated in FIG. 5B with use of a known technique such as Angle of Arrival (AoA) or Angle of Departure (AoD) in Bluetooth. Furthermore, the three-dimensional coordinate system illustrated in FIG. 5B is a coordinate system in which the front direction of the HMD 1 is set to Z-axis, the horizontal direction thereof is set to X-axis, and the vertical direction thereof is set to Y-axis and the angle θ is an angle formed on the XZ plane and the angle φ is an angle formed on the YZ plane. The reception unit 206 outputs, to the instruction unit 204, information about the distance d and angles (θreal, φreal) between the HMD 1 and the printer 3 acquired in the above-mentioned way.

Next, a functional configuration of the PC 2, which is a second information processing apparatus different from an HMD, is described.

The PC 2 includes, as illustrated in FIG. 4, a PC communication unit 207, an application processing unit 208, an image drawing unit 209, and a print job generation unit 210. Furthermore, while the PC 2 also includes, in addition to the functional units illustrated in FIG. 4, various functional units which a general personal computer includes, the illustration and description thereof are omitted.

The PC communication unit 207 acquires the drag coordinates (Udrag, Vdrag, Ddrag) transmitted from the transmission unit 205 of the HMD 1, the display range information (Uvd, Vvd, Wvd, Hvd) about the virtual display 6, and the instruction information generated by the instruction unit 204. Then, the PC communication unit 207 outputs the drag coordinates (Udrag, Vdrag, Ddrag) to the application processing unit 208. Moreover, the PC communication unit 207 outputs the display range information (Uvd, Vvd, Wvd, Hvd) about the virtual display 6 to the application processing unit 208 and the image drawing unit 209. Moreover, the PC communication unit 207 outputs the instruction information to a functional unit associated with the instruction information. In the case of the first embodiment, since, in the instruction unit 204 of the HMD 1, print instruction information is generated as instruction information associated with a drop operation with respect to the printer 3, the PC communication unit 207 outputs the print instruction information to the print job generation unit 210.

The application processing unit 208 manages processing of the application in the PC 2 and the coordinates of the application window. Furthermore, for the description, it is assumed that the resolution of a displayed image in the PC 2 is equal to a resolution determined by the width Wvd and height Hvd of the virtual display 6. Moreover, the operating system (OS) of the PC 2 is assumed to be managing in which region within the range in width and height (Wvd×Hvd) of the display screen of the PC 2 to display each of all of the application windows which are being used. Moreover, the central coordinates of the display region of the application window are assumed to be (Uaw, Vaw) and the width and height thereof are assumed to be represented by Waw and Haw, respectively. Moreover, as mentioned above, there are various applications of the application windows, such as a PDF viewer and a video viewer, and, in the first embodiment, the PDF viewer is particularly taken as an example. Then, the application processing unit 208 outputs, to the PC communication unit 207, application data about an application window which the user of the HMD 1 is dragging to outside the display range of the virtual display 6. Moreover, the application processing unit 208 outputs information about the display region of the application window and a result of processing performed by the application to the image drawing unit 209.

The image drawing unit 209 draws an image which is to be displayed on the display of the PC 2, based on the display region of the application window and a result of processing performed by the application. Moreover, the image drawing unit 209 outputs, to the PC communication unit 207, display data about an image which is to be displayed on the display of the PC 2.

The PC communication unit 207 transmits, to the HMD 1, application data about the application window transmitted from the application processing unit 208 and, moreover, transmits, to the HMD 1, display data transmitted from the image drawing unit 209.

The print job generation unit 210 generates a print job based on the instruction information (in the case of an example in the first embodiment, the print instruction information) which the PC communication unit 207 has received from the HMD 1, and transmits the generated print job to the printer 3. Furthermore, the print job can be transmitted to the printer 3 via the PC communication unit 207.

Next, a functional configuration of the printer 3 is described.

The printer 3 includes, as illustrated in FIG. 4, a printer communication unit 211 and a printing unit 212. Furthermore, while the printer 3 also includes, in addition to the functional units illustrated in FIG. 4, various functional units which a general printer includes, the illustration and description thereof are omitted.

The printer communication unit 211 received a print job from the PC 2.

The printing unit 212 performs printing based on the print job.

Then, after printing has ended, the printing unit 212 transmits print end information to the PC 2 via the printer communication unit 211.

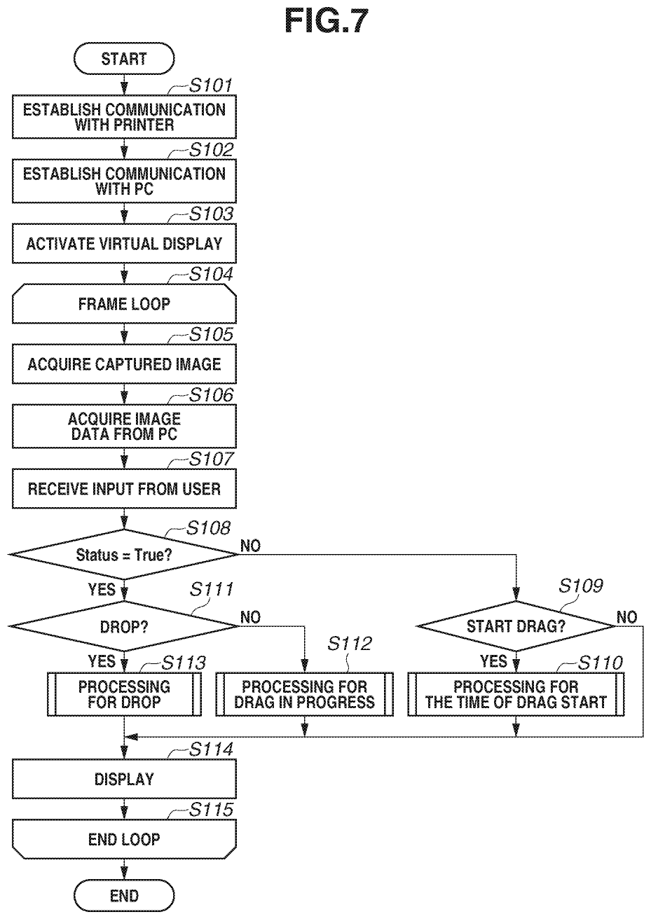

FIG. 7 is a flowchart illustrating the flow of information processing according to the first embodiment, which is performed in the HMD 1.

First, in step S101, the reception unit 206 performs processing for establishing a communication between the HMD 1 and the printer 3. In the case of the first embodiment, for example, Bluetooth is assumed to be used for a communication between the HMD 1 and the printer 3. Therefore, each of the HMD 1 and the printer 3 includes an I/F for Bluetooth communication. In a case where pairing for Bluetooth communication between the HMD 1 and the printer 3 has still not been established, the reception unit 206 establishes a communication between the HMD 1 and the printer 3 with use of a known pairing method.

Next, in step S102, the reception unit 206 performs processing for establishing a communication between the HMD 1 and the PC 2. In the case of the first embodiment, for example, Wi-Fi Direct® is assumed to be used for a communication between the HMD 1 and the PC 2. Therefore, each of the HMD 1 and the PC 2 includes an I/F for Wi-Fi connection. For example, in a case where the user of the HMD 1 has input a Service Set Identifier (SSID) and a password for Wi-Fi of the PC 2 via the input device 107, the reception unit 206 establishes a communication between the HMD 1 and the PC 2 with use of a known Wi-Fi communication establishment method.

Next, in step S103, in a case where the input unit 201 has received a user input for issuing an instruction to activate a virtual display from the user of the HMD 1, the input unit 201 activates the virtual display. Moreover, at this time, the range acquisition unit 202 acquires display range information (Uvd, Vvd, Wvd, Hvd) about the virtual display. Furthermore, the initial position of the virtual display to be used is assumed to be an initial value stored in, for example, the ROM 103.

Next, the HMD 1 advances the processing to loop processing starting with step S104 and ending with step S115. The loop processing starting with step S104 and ending with step S115 is performed for each frame of a moving image captured by the RGB camera mounted in the HMD 1.

During the loop processing, first, in step S105, the input unit 201 acquires image data about a moving image which the RGB camera mounted in the HMD 1 is capturing.

Next, in step S106, the reception unit 206 receives display data from the PC 2 and outputs the received display data to the display unit 203, and the display unit 203 acquires image data based on the display data and displays the acquired image data on the virtual display 6.

Next, in step S107, the input unit 201 receives an input from the user of the HMD 1. The input unit 201 at this time acquires a user input with use of a known hand gesture recognition technique based on images which are acquired in chronological order for each frame in step S105.

In the case of the first embodiment, the input unit 201 recognizes whether the user has performed a drag operation or a drop operation, by the hand gesture recognition processing. The details of processing for recognizing a drag operation or a drop operation by the hand gesture recognition processing are described below. Then, in the case of having recognized a drag operation, the input unit 201 acquires drag coordinates (Udrag, Vdrag, Ddrag), and, in the case of having recognized a drop operation, the input unit 201 acquires drop coordinates (Udrop, Vdrop, Ddrop).

Next, in step S108, the input unit 201 determines whether “Status”, which is an internally used variable status, is True. Furthermore, it is assumed that, immediately after activation of the virtual display, Status is preliminarily initialized to be False. Status is an internal variable which is controlled to be True when the user is performing a drag operation or when the user has performed a drop operation and to be False when the user has started a drag operation or when the user is performing neither a drag operation nor a drop operation. If it is determined that Status is False (NO in step S108), the input unit 201 advances the processing to step S109, and, on the other hand, if it is determined that Status is True (YES in step S108), the input unit 201 advances the processing to step S111.

In step S109, the input unit 201 determines whether the user input is the start of a drag operation based on a result of recognition performed in step S107. Then, if it is determined that the user input is the start of a drag operation (YES in step S109), the input unit 201 advances the processing to step S110, and, on the other hand, if it is determined that the user input is not the start of a drag operation (NO in step S109), the input unit 201 advances the processing to step S114.

In step S110, the input unit 201 and the display unit 203 perform processing for the time of drag operation start. The details of processing for the time of drag operation start are described below. After that, the HMD 1 advances the processing to step S114.

In step S111, the input unit 201 determines whether the user input is a drop operation based on a result of recognition performed in step S107. Then, if it is determined that the user input is a drop operation (YES in step S111), the input unit 201 acquires drop coordinates (Udrop, Vdrop, Ddrop) obtained at that time and then advances the processing to step S113, and, on the other hand, if it is determined that the user input is not a drop operation (NO in step S111), the input unit 201 advances the processing to step S112.

In step S112, each of the input unit 201, the display unit 203, and the transmission unit 205 performs processing responsive to a drag operation performed by the user. The details of processing responsive to a drag operation performed by the user are described below. After that, the HMD 1 advances the processing to step S114.

In step S113, each of the input unit 201, the instruction unit 204, and the transmission unit 205 performs processing responsive to a drop operation performed by the user. The details of processing responsive to a drop operation performed by the user are described below. After that, the HMD 1 advances the processing to step S114.

In step S114, the display unit 203 displays a video image corresponding to processing performed in step S110, step S112, or step S113 on the display of the HMD 1.

After that, in step S115, the HMD 1 returns the processing to step S105. This causes processing in step S105 and subsequent steps for a next frame to be performed. In this way, by repeating processing in step S105 to step S115, the HMD 1 is able to display, on the display thereof, a video image corresponding to the chronological order for each frame. As a result, the user is enabled to watch both a video image of the real-time real world and the virtual display.

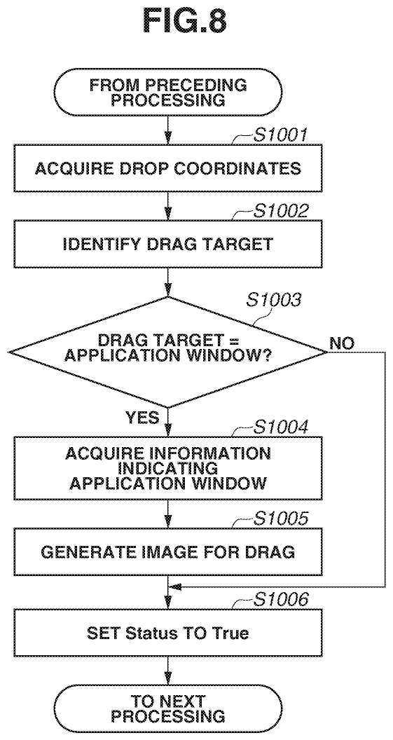

FIG. 8 is a flowchart illustrating the details of processing for the time of drag operation start in step S110 illustrated in FIG. 7.

First, in step S1001, the input unit 201 acquires drag coordinates (Udrag, Vdrag, Ddrag) obtained by known hand gesture recognition processing in step S107.

Next, in step S1002, the input unit 201 identifies a drag target obtained when the user has started a drag operation, based on the drag coordinates (Udrag, Vdrag, Ddrag) acquired in step S1001.

Next, in step S1003, the input unit 201 determines whether the drag target for the time of drag start identified in step S1002 is an application window within the virtual display.

Here, the user may drag, for example, a virtual object other than the application window within the virtual display. For example, when wanting to move the virtual display 6 itself or when wanting to move a virtual object which is other than the virtual display 6 and which the OS of the HMD 1 manages, the user may perform a drag operation with respect to such an object.

Therefore, in step S1003, the input unit 201 determines whether the drag target for the time of drag operation star is an application window within the virtual display. For example, if the UV coordinates (Udrag, Vdrag) of the drag coordinates are UV coordinates in the application window 4 or the application window 5 within the virtual display 6, the input unit 201 determines that the drag target is an application window. On the other hand, if the UV coordinates (Udrag, Vdrag) of the drag coordinates are not UV coordinates in the application window 4 or the application window 5, the input unit 201 determines that, for example, a virtual object other than the application window is the drag target.

To perform such determination processing, first, the input unit 201 calculates whether the UV coordinates (Udrag, Vdrag) of the drag coordinates are within the virtual display 6. For example, in a case where the following formulae (1) are satisfied, the input unit 201 determines that the drag target is within the virtual display 6.

$$Wvd / 2 < ( Uvd - Udrag ) < Wvd / 2 \qquad ( 1 )$$

$$Hvd / 2 < ( Vvd - Vdrag ) < Hvd / 2$$

Here, Uvd, Vvd, Wvd, and Hvd in formulae (1) are, as mentioned above, values representing a display range of the virtual display 6 in an image coordinate system which is displayed on the screen of the HMD 1. Moreover, (Uvd-Udrag) and (Vvd-Vdrag) in formulae (1) are drag coordinates in an image coordinate system of the virtual display 6 which the PC 2 draws.

Next, the input unit 201 determines whether the drag coordinates (Uvd−Udrag, Vvd−Vdrag) in an image coordinate system of the virtual display 6 which is displayed in the HMD 1 based on display data transmitted from the PC 2 are present within an application window within the virtual display 6. Here, the determination as to whether the drag coordinates are present within an application window can be performed by the input unit 201 of the HMD 1 or can be performed by the application processing unit 208 of the PC 2.

In the first embodiment, a case where the determination is performed by the application processing unit 208 of the PC 2 is taken as an example for description. In this case, the input unit 201 of the HMD 1 transmits the drag coordinates (Uvd−Udrag, Vvd−Vdrag) to the PC 2 via the transmission unit 205.

The application processing unit 208 of the PC 2 determines whether the drag coordinates (Uvd−Udrag, Vvd−Vdrag) transmitted from the HMD 1 are present within the application window, based on whether, for example, the following formulae (2) are satisfied. Thus, the application processing unit 208 performs determination processing for formulae (2) based on information about the drag coordinates (Uvd−Udrag, Vvd−Vdrag) and the UV coordinates (Uaw, Vaw), the width Waw, and the height Haw of the application window.

$$( Uaw - Waw / 2 ) < ( Uvd - Udrag ) < ( Uaw + Waw / 2 ) \qquad ( 2 )$$

$$( Vaw - Haw / 2 ) < ( Vvd - Vdrag ) < ( Vaw + Haw / 2 )$$

The application processing unit 208 of the PC 2 acquires a determination result using formulae (2) with respect to all of the application windows within the virtual display, and determines within which application window the drag coordinates are present. Furthermore, in a case where, for example, a plurality of application windows is overlapping on the screen, as a determination result using the above-mentioned formulae (2), it may be calculated that the drag coordinates are present within a plurality of application windows. In this case, based on front-back information about overlapping of application windows, the application processing unit 208 determines that a drag operation is being performed with respect to the frontmost application window.

Then, the application processing unit 208 outputs, to the PC communication unit 207, a determination result indicating whether the above-mentioned drag target is present within the application window, and the PC communication unit 207 transmits the determination result to the HMD 1.

The reception unit 206 of the HMD 1 outputs the received determination result to the input unit 201. Furthermore, since this determination result is used for processing to be performed for a next and subsequent frames, the input unit 201 saves the determination result in a storage unit such as the ROM 103.

If, in step S1003, it is determined that the drag target is an application window present within the virtual display (YES in step S1003), the HMD 1 advances the processing to step S1004, and, if it is determined not so (NO in step S1003), the HMD 1 advances the processing to step S1006.

In step S1004, the reception unit 206 acquires information indicating the application window determined to be the drag target. In the case of the first embodiment, the drag target is assumed to be the application window 5. Moreover, the reception unit 206 at this time acquires, from the PC 2, information indicating the type of the application, thus indicating that the application of the application window 5 is a PDF viewer.

Next, in step S1005, the display unit 203 generates an image for drag. The display unit 203 generates, as an image for drag, an icon image corresponding to the application type of the application window. In the case of the first embodiment, a plurality of icon images corresponding to a plurality of types of applications is preliminarily stored in a storage unit such as the ROM 103 of the HMD 1. Moreover, in an example in the first embodiment, since the application of the application window 5 is a PDF viewer, the display unit 203 reads out, from the storage unit, an icon image indicating a PDF viewer and displays the read-out icon image as an image for drag. Furthermore, for example, the PC 2 can generate an icon image, and, in this case, the reception unit 206 of the HMD 1 receives an icon image transmitted from the PC 2 and the display unit 203 displays the received icon image as an image for drag. After that, the HMD 1 advances the processing to step S1006.

In step S1006, the input unit 201 sets Status to True.

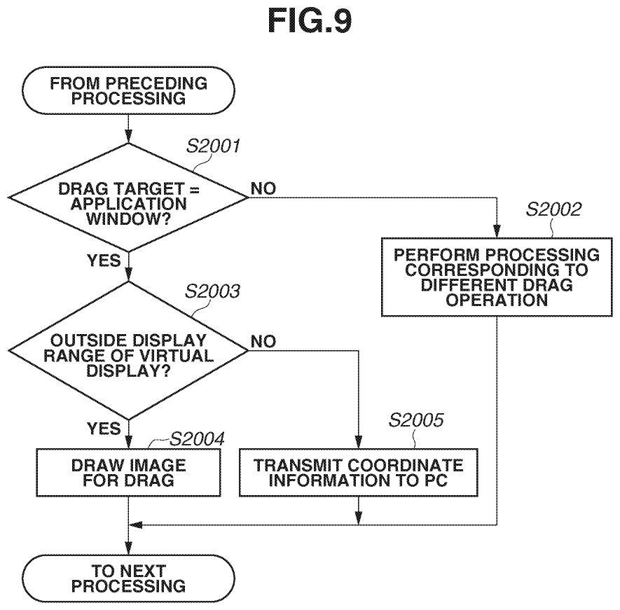

FIG. 9 is a flowchart illustrating the details of processing which is performed when a drag operation is in progress in step S112 illustrated in FIG. 7.

First, in step S2001, the input unit 201 determines whether the drag target is an application window. Then, if it is determined that the drag target is an application window (YES in step S2001), the input unit 201 advances the processing to step S2003, and, on the other hand, if it is determined not so (NO in step S2001), the input unit 201 advances the processing to step S2002. Furthermore, in this determination, a result obtained at the last minute by performing the above-mentioned step S1002 illustrated in FIG. 8 can be used.

In step S2002, the input unit 201 performs processing corresponding to a different drag operation. The different drag operation is processing corresponding to a drag operation for, for example, a virtual object other than application windows. As an example, in a case where the different drag operation is a drag operation for any one of left, right, upper, and lower edges of the virtual display 6, the input unit 201 changes the values of the above-mentioned display range information (Uvd, Vvd, Wvd, Hvd) about the virtual display 6 according to such a drag operation. Moreover, for example, in a case where the different drag operation is a drag operation for any one of four corners of the virtual display 6, the input unit 201 enlarges or reduces the display range of the virtual display 6 according to such a drag operation. Thus, in this case, the input unit 201 changes the width (Wvd) and height (Hvd) of the virtual display 6.

While, in addition, processing corresponding to various drag operations is conceivable, the description of such processing is omitted here.

In step S2003, the input unit 201 determines whether the drag coordinates are outside the display range of the virtual display 6. Then, if, in step S2003, it is determined that the drag coordinates are outside the display range of the virtual display 6 (YES in step S2003), the HMD 1 advances the processing to step S2004, and, on the other hand, if it is determined that the drag coordinates are within the display range (NO in step S2003), the HMD 1 advances the processing to step S2005.

In step S2004, the display unit 203 draws an image for drag at the position of the drag coordinates. Thus, the display unit 203 draws an image for drag with the center thereof set to the drag coordinates (Udrag, Vdrag, Ddrag).

In step S2005, the input unit 201 transmits the drag coordinates (Udrag, Vdrag, Ddrag) to the PC 2. Furthermore, a drag operation within the display range of the virtual display can be considered as a drag operation for the user to move the application window inside the virtual display. Therefore, in a case where a drag operation is being performed within the display range of the virtual display, the display unit 203 performs, without drawing an image for drag, only transmitting the drag coordinates to the PC 2. The PC 2 is able to move the application window within the display range of the virtual display based on the drag coordinates.

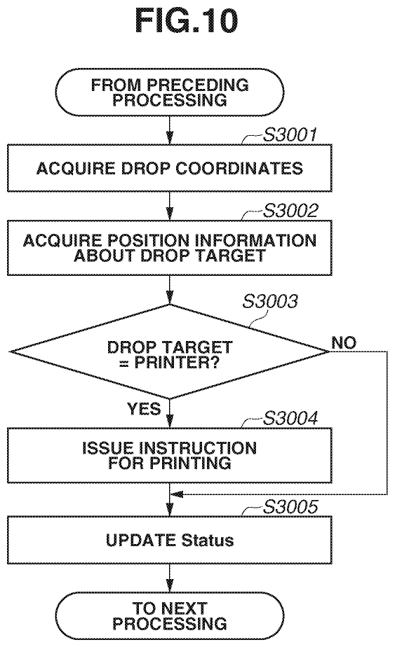

FIG. 10 is a flowchart illustrating the details of processing which is performed at the time of a drop operation in step S113 illustrated in FIG. 7.

First, in step S3001, when having recognized a drop operation by known hand gesture recognition processing, the input unit 201 acquires drop coordinates (Udrop, Vdrop, Ddrop) obtained at that time.

Next, in step S3002, the instruction unit 204 acquires position information representing a positional relationship between the HMD 1 and the drop target from the reception unit 206. In the case of the first embodiment, since the drop target is the printer 3, the instruction unit 204 acquires position information representing a positional relationship between the HMD 1 and the printer 3. In the case of the first embodiment, the instruction unit 204 acquires the distance d and angles (θreal, φreal) between the HMD 1 and the printer 3 from the reception unit 206.

Next, in step S3003, the instruction unit 204 determines whether the drop target is the printer 3. In the case of the first embodiment, the instruction unit 204 determines whether the drop target is the printer 3, based on a result obtained by comparing the distance between the drop target and the printer 3 with a predetermined threshold value.

To perform this determination, the instruction unit 204 converts the drop coordinates represented by the UV coordinates into the drop coordinates represented by the θφ coordinates. For example, in the case of an HMD in which the resolution per angle (pixels per degree (ppd)) is constant, the instruction unit 204 converts the UV coordinates (Udrop, Vdrop) into the θφ coordinates (θdrop, φdrop) by the following formulae (3).

$$θ drop = Udrop * ppd \qquad ( 3 )$$

$$φ drop = Vdrop * ppd$$

Then, if both a difference between the values θdrop and θreal and a difference between the values φdrop and φreal are less than a predetermined threshold value θth and a difference between the distance d and the value Ddrop is less than a predetermined threshold value dth, the instruction unit 204 determines that the drop target is the printer 3.

If it is determined that the drop target is the printer 3 (YES in step S3003), the instruction unit 204 advances the processing to step S3004, and, if it is determined that the drop target is not the printer 3 (NO in step S3003), the instruction unit 204 advances the processing to step S3005.

In step S3004, the instruction unit 204 generates print instruction information for the PC 2, the transmission unit 205 transmits the print instruction information to the PC 2, and, after that, the HMD 1 advances the processing to step S3005. Furthermore, while the print instruction information which the PC 2 has received includes print settings as a print job, the print settings included in the print job are assumed to be default print setting values of the application window 5. After step S3004, the HMD 1 advances the processing to step S3005.

In step S3005, the input unit 201 sets Status to False.

While, in the above-described first embodiment, an example in which a hand gesture which brings the middle finger and thumb of one hand of the user into contact with each other, moves the position of the hand in that state, and then separates the middle finger and thumb from each other is recognized as a drag-and-drop operation has been described, the first embodiment is not limited to this example. For example, the fingers to be used are not limited to the middle finger and thumb and another finger can also be used, and drag and drop can be performed with use of, for example, a mouse or touch panel connected to the HMD 1. Moreover, an image for drag can be operated by a gesture other than drag and drop. For example, the input unit 201 can detect the user's action for throwing an image for drag and calculate a movement locus corresponding to the throwing action, and the display unit 203 can display the image for drag in such a manner that the image for drag moves on the movement locus. Moreover, for example, the input unit 201 can determine whether an image for drag which is moving has collided with an object such as a printer and, in a case where the image for drag has collided with an object, the instruction unit 204 can generate transmission instruction information for application data corresponding to the object and transmit the transmission instruction information to the object.

While, in the above-described first embodiment, an example in which, in step S3003, it is determined whether drag has been performed on the printer 3, according to the distance and angles between the drag coordinates and the printer 3 has been described, this determination can be performed based on only the angles. For example, based on only the angles, the instruction unit 204 is able to instruct a more distant printer to print application data about the application window.

While, in the above-described first embodiment, an example in which drag and drop is performed on a real printer has been described, the drop target is not limited to a real printer. For example, the drop target can be a display device such as digital signage. For example, in a case where the application window 5 has been dropped onto real digital signage, then in step S3003 illustrated in FIG. 10, the instruction unit 204 generates transmission instruction information for issuing an instruction for transmitting application data to the digital signage. Then, the transmission unit 205 transmits the transmission instruction information to the PC 2. Based on the transmission instruction information, the PC 2 transmits application data about the application window 5 to digital signage (not illustrated) with use of a communication technique such as Wi-Fi. The digital signage once stores the application data transmitted from the PC 2 in a storage device such as a hard disk drive (HDD) and, after that, reads out and displays the application data on a digital signage display unit (not illustrated). With this configuration, the user of the HMD 1 becomes able to easily share application data about the application window 5, at which the user is looking, with another person by displaying performed via the digital signage.

While, in the above-described first embodiment, an example in which processing is performed on one real printer has been described, processing can be performed on a plurality of printers. Moreover, for example, drag and drop can be performed with respect to one or more pieces of equipment of each of two or more types of equipment such as a printer and digital signage. For example, pairing for Bluetooth is preliminarily performed between all of the pieces of equipment and the HMD 1. Then, the HMD 1 acquires position information about the distance and angles with respect to each paired equipment in a way similar to that in the above-mentioned step S3002. Next, the HMD 1 obtains differences with respect to the angles and distance for the respective pieces of equipment in a way similar to that in step S3002 and then obtains equipment closest to the drag coordinates from among the paired pieces of equipment. Then, if the angles and distance of the closest equipment are less than threshold values, the HMD 1 determines that the user has performed drop onto the closest equipment and then advances the processing to step S3004. On the other hand, if there is no equipment the angles and distance of which are less than threshold values, the HMD 1 advances the processing to step S3005. Moreover, without issuing an instruction for printing in step S3004, the HMD 1 generates an instruction conforming with the type of the closest equipment and transmits the generated instruction.

While, in the above-described first embodiment, an example in which an application window is dragged and dropped onto a real printer has been described, drag and drop can be performed onto a virtual printer corresponding to the real printer. In the case of such an example, the real printer 3 illustrated in FIG. 2 is assumed to be installed, for example, at a distant position which is not displayed in the screen of the HMD 1, and a virtual printer representing the real printer 3 is assumed to be displayed at the position of the printer 3 illustrated in FIG. 2. In the case of such an example, the three-dimensional shape and orientation of the virtual printer are assumed to be managed in the HMD 1. Therefore, even without use of a method for acquiring position information between the HMD 1 and an object by Bluetooth, the HMD 1 is able to acquire position information indicating a positional relationship between the HMD 1 and the virtual printer. Thus, in the case of such an example, in step S3003, based on the position information between the HMD 1 and the virtual printer, the instruction unit 204 determines whether drag and drop has been performed on the above-mentioned printer. Moreover, drag and drop can be performed on, instead of a virtual printer, a virtual object which does not exist in reality. As an example, drag and drop can be performed on, for example, a calling application or message application which runs on the HMD 1. In this case, the HMD 1 transmits application data corresponding to the dragged image for drag to a virtual object serving as the drop target.

While, in the above-described first embodiment, Bluetooth is used to acquire position information between the HMD 1 and a real object such as a real printer or digital signage, another method or another combination other than Bluetooth can be used. As an example, a known object recognition technique can be used. For example, the printer communication unit 211 transmits a printer appearance image to the HMD 1. Then, based on the printer appearance image, the HMD 1 obtains image coordinates of the printer 3 from an image captured by the RGB camera of the HMD 1 by a known image matching technique. Then, the HMD 1 converts the image coordinates into angle information by using the above-mentioned formulae (2), and performs drop determination by the processing in step S3003. Moreover, the distance and angles can be obtained with use of a combination of Bluetooth and the angles and distance in object recognition.

In the above-described first embodiment, an example in which, in step S3004, the print settings are set to default settings has been described. Here, when having performed drag and drop, the user may want to confirm or change print settings. In this case, in step S3004, the print job generation unit 210 can generate a UI for enabling changing print settings, and transmit the generated UI from the PC communication unit 207 to the HMD 1. Then, in a case where, for example, the user has changed print settings via the UI, the print job generation unit 210 can receive information about the print settings and generate a print job that is based on the print settings.

While, in the above-described first embodiment, in step S1005, the display unit 203 generates an icon image corresponding to the type of the application as an image for drag, another image can be generated. For example, the HMD 1 can store an image present inside the display region of the application window for the time of drag start, and then use the stored image as an image for drag. Moreover, the HMD 1 can set, as an image for drag, an image obtained by rendering a three-dimensional model of mesh or point group data associated with the application. For example, with respect to a PDF viewer, the HMD 1 can generate a document model of a planar model that is based on the paper size of the print settings and use the generated document model as an image for drag. Thus, the size of an image for drag can be determined based on the paper size of the print settings for the printer. For example, in the case of dragging a PDF viewer of the print settings corresponding to A4 size, the HMD 1 can set, as an image for drag, an image obtained by rendering a planar model of A4 size to the drag coordinate position by a known rendering method.

While, in the above-described first embodiment, it has been described that a captured image obtained by the RGB camera of the HMD 1 and a display image are in the same coordinate system, there is a case where the lens of the RGB camera and the eyepiece lens of the HMD 1 differ in distortion from each other or the number of pixels of the RGB camera and the number of pixels of the display of the HMD 1 differ from each other. In such a case, differences can be addressed by converting coordinate systems and performing processing with the converted coordinate systems by known distortion correction processing or an enlargement or reduction technique.

As described above, according to the first embodiment, using an image for drag enables implementing an operation for dragging an application window to outside a display range of the virtual display. As a result, it becomes possible to transmit application data to an object such as a real printer or digital signage by a drop operation, so that it is possible to achieve a UI which is intuitive from the user's perspective.

### Second Embodiment

In the above-described first embodiment, an example in which, in a case where the user of the HMD drags an application window to outside a display range of the virtual display, an image for drag is displayed and the image for drag is dropped onto, for example, an object located outside the display range of the virtual display has been described.

In a second embodiment, an example in which delivery and receipt of data between a plurality of users are enabled by a drag operation using an image for drag is described. Furthermore, the hardware configuration and functional configuration of an information processing apparatus according to the second embodiment are similar to those in the above-described first embodiment and are, therefore, omitted from description. In the following second embodiment, portions different from those in the first embodiment are mainly described.

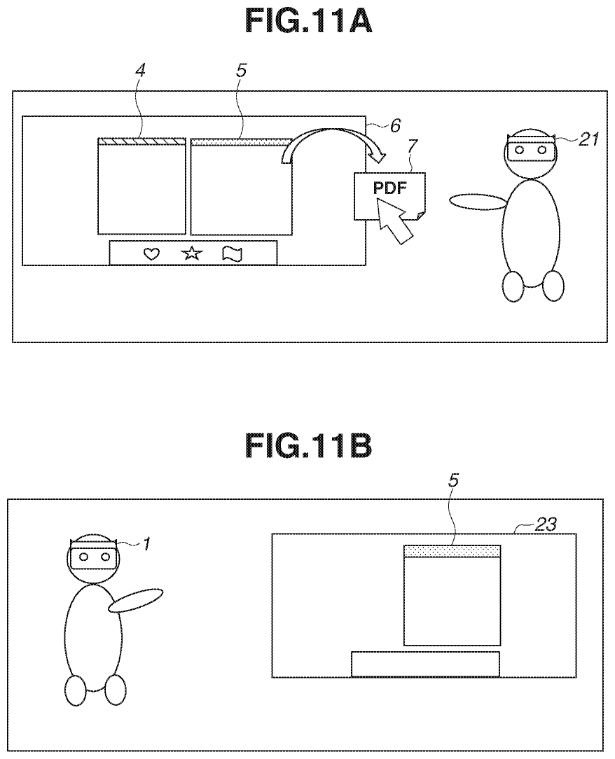

FIGS. 11A and 11B are conceptual diagrams illustrating an example of using an image for drag in the second embodiment.

FIG. 11A is a diagram illustrating an example of a video image which is displayed on the display of the HMD 1 when the user is dragging an image for drag. As illustrated in FIG. 11A, on the display of the HMD 1, for example, a virtual display 6, an application window 4 and an application window 5 which are displayed in the virtual display 6, and an image for drag 7 are displayed. Moreover, on the display of the HMD 1, another HMD 21 and the user thereof, image capturing of which is being performed by the RGB camera of the HMD 1, are also displayed. Furthermore, the virtual display 6 is a display in which a display image of the PC 2 (not illustrated) is shown as described above in the first embodiment.

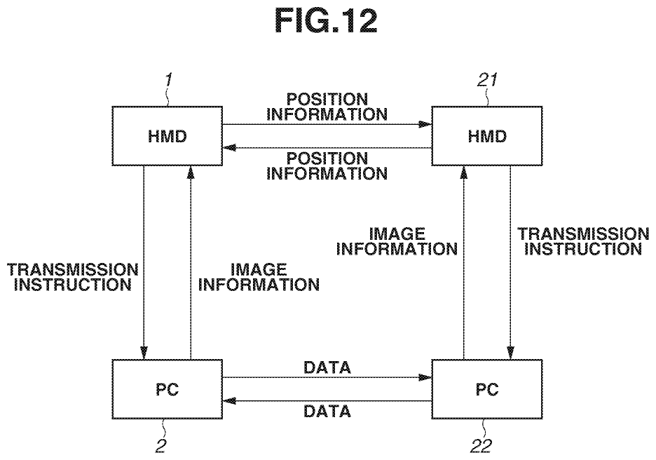

The user of the HMD 1 is dragging the application window 5 to outside the display range of the virtual display 6. At that time, the HMD 1 displays an image for drag 7 similar to that described above in the first embodiment. This enables the user to perform drag while looking at the image for drag 7. The example illustrated in FIG. 11A represents a manner in which the user of the HMD 1 is dragging the image for drag 7 toward the HMD 21 of the second user. Here, in a case where the user has dropped the image for drag 7 onto the HMD 21 of the second user, the instruction unit 204 of the HMD 1 generates transmission instruction information which indicates transmitting application data associated with the image for drag 7 from the PC 2 to the HMD 21. Upon receiving the transmission instruction information from the HMD 1, the PC 2 in the case of the second embodiment transmits the application data associated with the image for drag 7 to a PC 22 (FIG. 12), which is connected to the HMD 21 of the second user. Then, the PC 22 transmits the application data received from the PC 2 to the HMD 21. This enables the HMD 21 to receive the application data associated with the image for drag 7.

FIG. 11B is a diagram illustrating a screen example in which an image represented by display data which the PC 22 has generated based on the application data transmitted from the PC 2 according to drag and drop performed by the user of the HMD 1 has been displayed on the display of the HMD 21. As illustrated in FIG. 11B, on the display of the HMD 21, a virtual display 23 corresponding to the display screen of the PC 22 is being displayed. Then, in the virtual display 23, the application window 5 received from the PC 2 is being displayed. In the case of the example illustrated in FIG. 11B, upon receiving, from the HMD 1, the transmission instruction information for transmitting the application window 5 to the HMD 21, the PC 2 copies application data about the application window 5. Then, the PC 2 transmits the copied application data to the PC 22, which is connected to the HMD 21. The PC 22 transmits the copied application data received from the PC 2 to the HMD 21. This enables the user of the HMD 21 to view the application window 5 similar to the application window 5 of the HMD 1.

Furthermore, while, with reference to FIGS. 11A and 11B, an example in which an application window is delivered from the HMD 1 to the HMD 21 has been described, similarly, the HMD 21 is able to deliver an application window of the PC 22 to the HMD 1. As a result, the user of the HMD 1 and the user of the HMD 21 become able to deliver and receive pieces of data in the respective PCs between each other with use of respective intuitive UIs.

FIG. 12 is a diagram illustrating a data flow occurring when the HMD 1 and the HMD 21, each of which is an eyewear-type information processing apparatus, deliver and receive application windows via the PC 2 and the PC 22, each of which is a second information processing apparatus. Furthermore, each of the HMD 1 and the HMD 21 includes the functional units illustrated in FIG. 4, and each of the PC 2 and the PC 22 also includes the functional units illustrated in FIG. 4.

For example, a case where, in the HMD 1, the user drags an application window to the HMD 21 is described.

In this case, the reception unit 206 of the HMD 21 acquires position information representing the position and angles between the HMD 21 and the HMD 1 by performing processing using AoA or AoD in Bluetooth or HADM in a manner similar to that performed between the HMD 1 and the printer 3 mentioned above. Then, the transmission unit 205 of the HMD 21 transmits the acquired position information to the HMD 1.

The instruction unit 204 of the HMD 1 generates transmission instruction information for issuing an instruction for transmitting application data about the application window to the PC 22 connected to the HMD 21. Then, the transmission unit 205 of the HMD 1 transmits the transmission instruction information generated by the instruction unit 204 to the PC 2. The PC communication unit 207 of the PC 2, which has received the transmission instruction information, copies application data about the application window and transmits the copied application data to the PC 22.

The PC communication unit 207 of the PC 22 receives the copied application data transmitted from the PC 2. The image drawing unit 209 of the PC 22 generates display data about an image to be displayed on a virtual display, based on the copied application data. Then, the PC communication unit 207 of the PC 22 transmits the generated display data to the HMD 21.

Furthermore, it is also possible to, in contrast to the above-mentioned data flow, perform processing for dragging an application window in the HMD 21 to the HMD 1. In this case, the HMD 1 acquires position information representing the position and angles between the HMD 1 and the HMD 21 and transmits the position information to the HMD 21. Moreover, the instruction unit 204 of the HMD 21 generates transmission instruction information for issuing an instruction for transmitting application data about the application window to the PC 2 connected to the HMD 1, and the transmission unit 205 of the HMD 21 transmits the transmission instruction information to the PC 22. The PC communication unit 207 of the PC 22 copies application data about the application window and transmits the copied application data to the PC 2. The PC communication unit 207 of the PC 2 receives the copied application data transmitted from the PC 22. The image drawing unit 209 of the PC 2 generates display data about an image to be displayed on a virtual display, based on the copied application data. Then, the PC communication unit 207 of the PC 2 transmits the generated display data to the HMD 1.

In the case of the second embodiment, processing which the HMD 1 performs is processing almost similar to the processing described above with reference to FIG. 7, but differs in processing which is performed at the time of a drop operation in step S113.

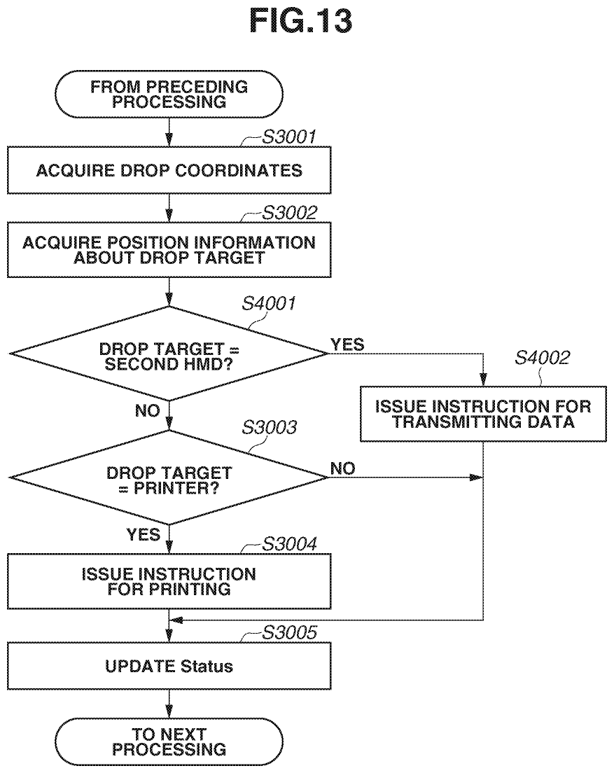

FIG. 13 is a flowchart illustrating processing in step S113 in the second embodiment. Furthermore, in FIG. 13, processing steps similar to those in FIG. 10 are assigned the respective same reference characters as those in FIG. 10 and are omitted from description here.

In the case of the second embodiment, in step S3002, the instruction unit 204 performs processing similar to that in the first embodiment and thus acquires position information represented by the position and angles between the drop coordinates and the HMD 21.

Next, in step S4001, the instruction unit 204 determines whether the drop target is the second HMD 21. In the case of the second embodiment, the instruction unit 204 determines whether the drop target is the HMD 21, based on a result of comparison between the distance between the drop target and the HMD 21 and a predetermined threshold value. Then, if the distance is less than the predetermined threshold value (YES in step S4001), the instruction unit 204 advances the processing to step S4002, and, on the other hand, if the distance is greater than or equal to the predetermined threshold value (NO in step S4001), the instruction unit 204 advances the processing to step S3003.

In step S4002, the instruction unit 204 generates transmission instruction information for instructing the PC 2 to copy application data about the application window 5 and transmit the copied application data to the PC 22 connected to the HMD 21. Then, the transmission unit 205 transmits the transmission instruction information to the PC 2. After step S4002, the HMD 1 advances the processing to step S3005.

In the second embodiment, delivery and receipt of data can be performed between a plurality of users (a plurality of HMDs) by a drag operation. With this configuration, according to the second embodiment, the respective users of a plurality of HMDs become able to deliver and receive an application window between each other with use of respective intuitive UIs.

### Modification Examples

In the above-described second embodiment, an example in which, based on the transmission instruction information transmitted from the HMD 1, the PC 2 copies application data and transmits the copied application data to the PC 22, and the PC 22 transmits the copied application data to the HMD 21, or delivery and receipt opposite to the above-mentioned sequence are performed has been described.

Here, as a modification example of the second embodiment, an example in which application data from the PC 2 is transmitted to, for example, the HMD 21 or the printer 3 via the HMD 1 or cloud computing described below is described. Furthermore, the configuration of an information processing apparatus in the modification example is similar to that in the above-described second embodiment and is, therefore, omitted from description. In the following description, portions different from those in the above-described second embodiment are mainly described.

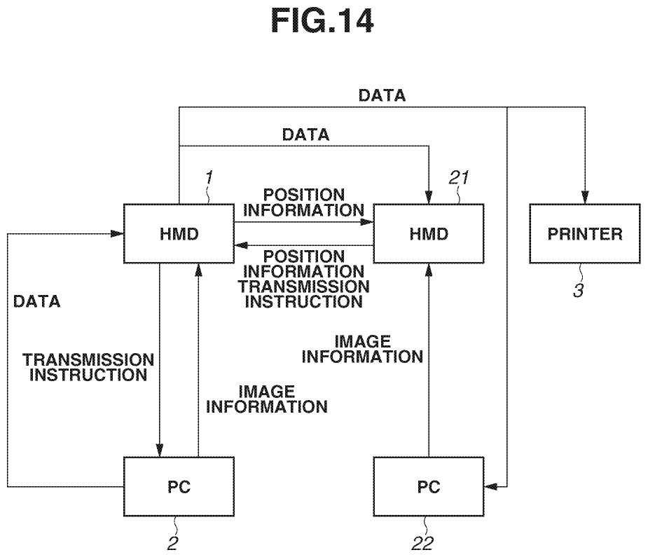

FIG. 14 is a diagram illustrating a data flow in a first modification example in which the HMD 1 transfers data transmitted from the PC 2 to, for example, the PC 22 or the printer 3. Furthermore, each of the HMD 1 and the HMD 21 illustrated in FIG. 14 includes the functional units of the HMD illustrated in FIG. 4, each of the PC 2 and the PC 22 includes the functional units of the PC illustrated in FIG. 4, and the printer 3 includes the functional units of the printer illustrated in FIG. 4. With reference to FIG. 14, only processing different from that in the above-described data flow illustrated in FIG. 12 is described.

First, a data flow in which the PC 2 transfers a print job to the printer 3 via the HMD 1 is described.

The transmission unit 205 of the HMD 1 transmits, to the PC 2, transmission instruction information for application data similar to that in the above-described second embodiment.

In response to a transmission request from the HMD 1, the PC 2 generates a print job that is based on application data, and transmits the print job to the HMD 1.

The HMD 1 transfers the print job to the printer 3.

Furthermore, the HMD 1 can be configured to include the function of generating a print job based on the application data.

In this case, the transmission unit 205 of the HMD 1 transmits, to the PC 2, transmission instruction information for application data similar to the above-mentioned information.

The PC 2 transmits application data about the application window to the HMD 1.

Then, the HMD 1 generates a print job based on the received application data, and transmits the print job to the printer 3.

Next, a data flow in which the PC 2 transfers application data to the PC 22 via the HMD 1 is described.

The transmission unit 205 of the HMD 21 transmits transmission instruction information to the HMD 1.

Based on the transmission instruction information received from the HMD 21, the transmission unit 205 of the HMD 1 generates transmission instruction information for the PC 2, and transmits the generated transmission instruction information to the PC 2.

The PC 2, which has received the transmission instruction information from the HMD 1, transmits application data about the application window to the HMD 1.

The HMD 1, which has received the application data, transfers the received application data to the PC 22.

In this way, in the first modification example, even if a communication between the PC 2 and the printer 3 or a communication between the PC 2 and the PC 22 has not yet been established, it becomes possible to perform delivery and receipt of data via the HMD.

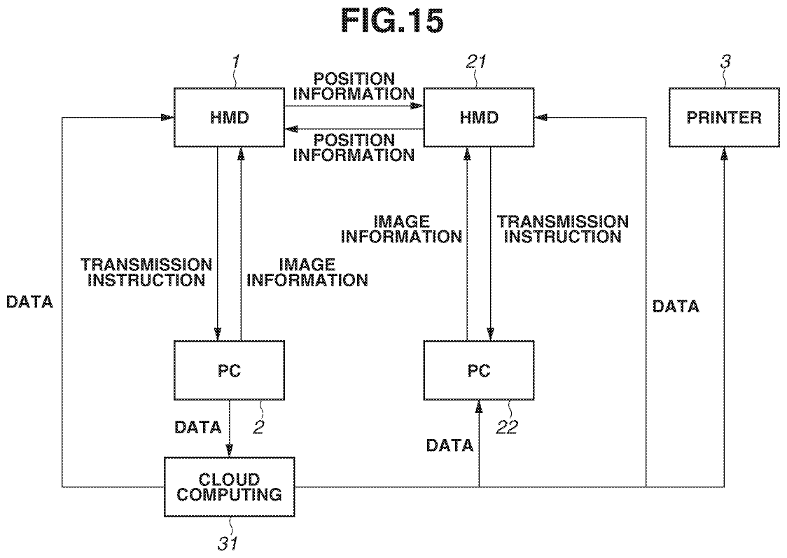

FIG. 15 is a diagram illustrating a data flow in a second modification example in which data transmitted from the PC 2 is transferred to, for example, the HMD 1, the PC 22, or the printer 3 via cloud computing 31. Furthermore, each of the HMD 1 and the HMD 21 illustrated in FIG. 15 includes the functional units of the HMD illustrated in FIG. 4, each of the PC 2 and the PC 22 includes the functional units of the PC illustrated in FIG. 4, and the printer 3 includes the functional units of the printer illustrated in FIG. 4. As illustrated in FIG. 15, the second modification example is directed to a configuration including, in addition to the HMD 1, the PC 2, the HMD 21, the PC 22, and the printer 3, the cloud computing 31. The cloud computing 31 is assumed to include a function serving as general cloud computing and to be connected to the HMD 1, the PC 2, the HMD 21, the PC 22, and the printer 3 via a network using the standard of, for example, Wi-Fi. Furthermore, with reference to FIG. 15, only processing different from that in the above-described data flow is described.

In the example illustrated in FIG. 15, when having received transmission instruction information from the HMD 1, the PC 2 uploads application data of the application window 5 to the cloud computing 31. Moreover, the PC 2 also uploads an instruction content represented by the transmission instruction information received from the HMD 1 to the cloud computing 31.

In a case where the instruction content transmitted from the PC 2 is a content for an instruction for printing, the cloud computing 31 generates a print job that is based on the application data and transmits the print job to the printer 3.

Moreover, in a case where the instruction content transmitted from the PC 2 is a content for an instruction for transmitting application data, the cloud computing 31 transfers the application data transmitted from the PC 2 to the HMD 1.

Moreover, in a case where the instruction content transmitted from the PC 2 is a content for an instruction for transmitting application data to the PC 22, the cloud computing 31 transfers the application data transmitted from the PC 2 to the PC 22.

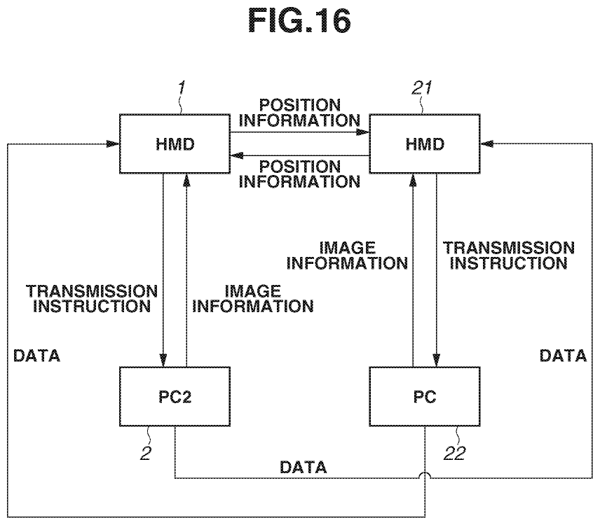

FIG. 16 is a diagram illustrating a data flow in a third modification example in which the PC directly transmits data to another HMD which is not the HMD which is transmitting display data for the virtual display. Furthermore, each of the HMD 1 and the HMD 21 illustrated in FIG. 16 includes the functional units of the HMD illustrated in FIG. 4, each of the PC 2 and the PC 22 includes the functional units of the PC illustrated in FIG. 4, and the printer 3 includes the functional units of the printer illustrated in FIG. 4. With reference to FIG. 16, only processing different from that in the above-described data flows is described.

In the example illustrated in FIG. 16, the HMD 1 transmits, to the PC 2, transmission instruction information for causing the PC 2 to transmit application data to the HMD 21.

In response to the transmission instruction information, the PC 2 transmits application data to the HMD 21.

Moreover, in the example illustrated in FIG. 16, the HMD 21 transmits, to the PC 22, transmission instruction information for causing the PC 22 to transmit application data to the HMD 1.

In response to the transmission instruction information, the PC 22 transmits application data to the HMD 1.

### Third Embodiment

In the above-described first embodiment, an example of enabling drag and drop to outside the display range of a virtual display has been described, and, in the above-described second embodiment, an example of enabling delivery and receipt of data using an image for drag between a plurality of users has been described.

In a third embodiment, an example in which, in a case where the user of the HMD has performed a drop operation to drop an image for drag onto an edge portion of the virtual display, an application window corresponding to the image for drag is displayed as a window of the HMD is described. Furthermore, the configuration of an information processing apparatus according to the third embodiment is similar to those in the first and second embodiments and is, therefore, omitted from description. In the following third embodiment, portions different from those in the above-described first and second embodiments are mainly described.

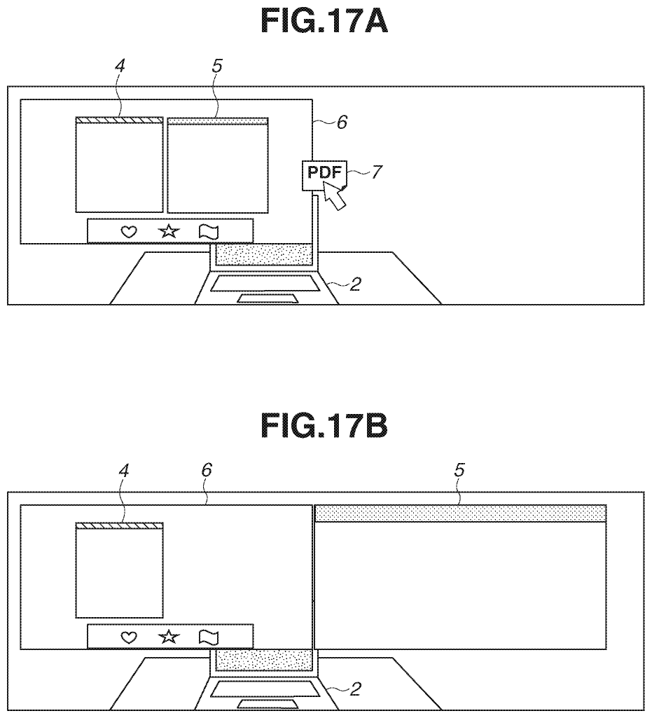

FIGS. 17A and 17B are diagrams illustrating display screen examples of a display of the HMD in the third embodiment.

FIG. 17A illustrates an example in which, in the display screen of the display of the HMD, for example, the PC 2, the virtual display 6, the application windows 4 and 5 contained in the virtual display 6, and the image for drag 7 are displayed. The example illustrated in FIG. 17A represents a display example obtained when the user is about to drop the image for drag 7 to an edge portion of the right side of the virtual display 6. Furthermore, the image for drag 7 is assumed to correspond to the application window 5.

FIG. 17B illustrates a display example obtained after the user has dropped the image for drag 7 to the edge portion of the virtual display 6. In a case where the image for drag 7 has been dropped to the edge portion of the right side of the virtual display 6, the HMD 1 displays the application window 5 corresponding to the image for drag 7 on the right side of the edge of the virtual display 6. The size of the application window 5 to be displayed at this time is assumed to be, for example, the same size as that of the virtual display 6.

In the case of the third embodiment, the application window 5 to be displayed on the right side of the virtual display 6 is assumed to be a window which has been activated by the application preliminarily installed on the HMD 1. Thus, in the case of the third embodiment, the HMD 1 has the function of activating an application window corresponding to an image for drag.

In the third embodiment, processing which is performed by the HMD or PC is processing almost similar to the processing described above with reference to FIG. 7 and the processing described above with reference to the data flow illustrated in FIG. 16 in the second embodiment, but differs in drop processing which is performed in step S113 illustrated in FIG. 7.

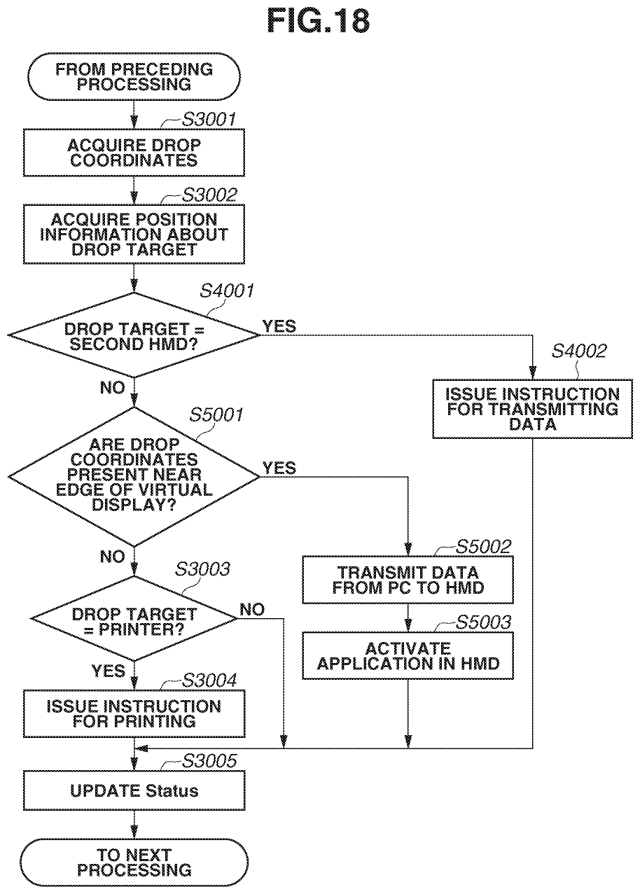

FIG. 18 is a flowchart illustrating drop processing which is performed in step S113 in the third embodiment. Furthermore, in the flowchart of FIG. 18, processing steps similar to those in the flowcharts of FIG. 10 and FIG. 13 described above are assigned the respective same reference characters as those in FIG. 10 and FIG. 13 and are omitted from description here.

In the flowchart of FIG. 18, if, in step S4001, it is determined that the drop target is not a second HMD (NO in step S4001), the instruction unit 204 advances the processing to step S5001.

In step S5001, the instruction unit 204 determines whether the drop coordinates in the image for drag 7 are present near the edge of the virtual display. At this time, the instruction unit 204 determines whether the values (Udrop, Vdrop) of the UV coordinates of the drop coordinates of the image for drag 7 are near each of the left edge, lower edge, right edge, and upper edge of the virtual display 6 by less than a threshold value with regard to the respective edges in this order. Here, a case where the instruction unit 204 determines whether, as in the example illustrated in FIG. 17A, the drop coordinates of the image for drag 7 are near the left edge of the virtual display is described.

If the difference between the U coordinate (Uvd−Wvd/2) of the left edge and the value Udrop of the drop coordinates is less than a threshold value, and, moreover, the value Vdrop of the drop coordinates is a value higher than the V coordinate (Vvd−Hvd/2) of the left edge and less than the value (Vvd+Hvd/2), the instruction unit 204 determines that the drop coordinates are present near the left edge. Furthermore, if the image for drag 7 has not been dropped near the left edge, the instruction unit 204 performs determination in a similar way with regard to the lower edge, right edge, and upper edge in order. Then, if it is determined that the drop coordinates are present near the edge of the virtual display (YES in step S5001), the instruction unit 204 advances the processing to step S5002, and, if it is determined not so (NO in step S5001), the instruction unit 204 advances the processing to step S3003.

In step S5002, the instruction unit 204 transmits, to the PC 2, transmission instruction information for instructing the PC 2 to transmit application data about the application window corresponding to the dropped image for drag 7 to the HMD 1. Even in the third embodiment, the dragged and dropped application window is assumed to be the application window 5 contained in the virtual display 6. Then, the PC 2, which has received the transmission instruction information, transmits application data about the application window 5 to the HMD 1.

Next, in step S5003, upon receiving the application data from the PC 2, the reception unit 206 of the HMD 1 outputs the received application data to the display unit 203. The display unit 203 at this time activates and displays an application window for the application data transmitted from the PC 2. In the case of the third embodiment, the application data transmitted from the PC 2 is a PDF file. Therefore, the display unit 203 activates an application for the PDF viewer preliminarily installed on the HMD 1, and displays the application window 5 on the right side of the virtual display 6. Thus, in the case of the third embodiment, by activating an application which has already been activated in the PC 2 as an application even in the HMD 1, the HMD 1 is able to display the application window.

In the third embodiment, when displaying an application window on the display of the HMD 1, the display unit 203 determines the size of the application window 5 to be displayed as the same width and height as those of the virtual display 6 as illustrated in FIG. 17B. Moreover, the display unit 203 displays the application window 5 just outside the edge of the virtual display 6, which has been determined as the vicinity of the drop coordinates in step S5001. Specifically, in a case where the image for drag 7 has been dropped to the edge of the left side of the virtual display 6, the display unit 203 activates the PDF viewer and thus displays the application window 5 with the central coordinates set as (Uvd−Wvd, Vvd), the width set as Wvd, and the height set as Hvd. Moreover, for example, in a case where the image for drag 7 has been dropped to the upper edge of the virtual display 6, the display unit 203 displays the application window 5 with the central coordinates set as (Uvd, Vvd+Hvd), the width set as Wvd, and the height set as Hvd. Moreover, for example, in a case where the image for drag 7 has been dropped to the lower edge of the virtual display 6, the display unit 203 displays the application window 5 with the central coordinates set as (Uvd, Vvd−Hvd), the width set as Wvd, and the height set as Hvd. Moreover, for example, in a case where the image for drag 7 has been dropped to the right edge of the virtual display 6, the display unit 203 displays the application window 5 with the central coordinates set as (Uvd+Wvd, Vvd), the width set as Wvd, and the height set as Hvd.

Furthermore, in step S5003, in a case where an application installed on the HMD 1 has been activated so that an application window has been displayed, since the application window 5 on the PC 2 becomes unnecessary, the PC 2 can end the application.

Moreover, while, in the example in step S5003, in the HMD 1, the application window 5 with same size as that of the virtual display 6 is activated, the size of the application window 5 does not necessarily need to be the same as that of the virtual display 6. For example, a default size can be preliminarily defined and the HMD 1 can read the preliminarily defined default size. Moreover, the HMD 1 can acquire the size of the application window 5 which has been running in the PC 2 and display the application window 5 with the same size as the acquired size.

Moreover, in the above description, an example in which an image for drag is dropped to the edge of the virtual display has been described, an image for drag can be dropped to another region other than the edge of the virtual display. In this case, the display unit 203 of the HMD 1 displays the application window at the position to which the image for drag has been dropped. Furthermore, in the case of this example, when, in step S3003, it is determined that the drop target is not a printer, the HMD 1 advances the processing to step S5002.

Moreover, in the above description, an example in which the application window is displayed at the position of the drop coordinates for an image for drag has been described, a configuration in which data related to an application other than the application window is opened at the position of the drop coordinates can be employed.

Moreover, in the above description, an example in which an application preliminarily installed on the HMD 1 is activated to display the application window has been described, an image of an application window which the PC 2 has generated can be displayed at the position of the drop coordinates for an image for drag.

According to the third embodiment, by performing drag and drop of an image for drag, it is possible to locate and display an application window at an edge portion of the display range of a virtual display or at a position outside the display range of the virtual display. According to the third embodiment, it is possible to further improve the visibility or operating efficiency of the user of the HMD.

The present disclosure can also be implemented by processing for supplying a program for implementing one or more functions of the above-described embodiments to a system or apparatus via a network or a storage medium and causing one or more processors in a computer of the system or apparatus to read out and execute the program. Moreover, the present disclosure can also be implemented by a circuit which implements one or more functions of the above-described embodiments (for example, an application specific integrated circuit (ASIC)).

Each of the above-described embodiments merely represents an example of concretization in implementing the present disclosure, and the technical scope of the present disclosure shall not be construed as being limited by these embodiments.

Thus, the present disclosure can be implemented in various manners without departing from the technical idea thereof or the principal features thereof.

According to embodiments of the present disclosure, it is possible to implement a UI which the user is able to intuitively operate.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-046637, filed Mar. 21, 2025, which is hereby incorporated by reference herein in its entirety.

What is claimed is:

1. An information processing apparatus configured to generate an image to be displayed on an eyewear-type display unit, the information processing apparatus comprising:
a reception unit configured to receive external data which a second information processing apparatus different from the information processing apparatus retains from the second information processing apparatus;
a generation unit configured to generate a virtual display for displaying an object corresponding to the external data on the display unit;
a range acquisition unit configured to acquire a display range of the virtual display in the display unit;
an input unit configured to acquire a user input;
an instruction unit configured to generate instruction information for the second information processing apparatus; and
a transmission unit configured to transmit the instruction information to the second information processing apparatus,
wherein, in a case where the user input for dragging the object to outside the display range has been acquired, the instruction unit generates, as the instruction information, processing which the second information processing apparatus is caused to perform depending on a position to which the object has been dragged.

2. The information processing apparatus according to claim 1, wherein the object is an image which the external data represents or an icon which represents the external data.

3. The information processing apparatus according to claim 2, wherein, in a case where a device in real space is present at a position to which the icon has been dropped, the instruction unit generates the instruction information for issuing an instruction for transmitting the external data corresponding to the icon to the device in real space.

4. The information processing apparatus according to claim 3,
wherein the device in real space is a printing apparatus, and
wherein the instruction unit generates the instruction information for issuing an instruction for generating a print job of the external data corresponding to the icon and transmitting the print job to the printing apparatus.

5. The information processing apparatus according to claim 4, wherein the generation unit determines a size of the icon based on a paper size in print settings for the printing apparatus.

6. The information processing apparatus according to claim 3,
wherein the device in real space is a display device including a storage device, and
wherein the instruction unit generates the instruction information for issuing an instruction for transmitting the external data corresponding to the icon to the display device.

7. The information processing apparatus according to claim 3,
wherein the device in real space is an eyewear-type display device, and
wherein the instruction unit generates the instruction information for issuing an instruction for transmitting the external data corresponding to the icon to the eyewear-type display device.

8. The information processing apparatus according to claim 2, wherein the generation unit generates the icon by rendering a three-dimensional model related to the external data.

9. An information processing method which an information processing apparatus configured to generate an image to be displayed on an eyewear-type display unit performs, the information processing method comprising:
receiving external data which a second information processing apparatus different from the information processing apparatus retains from the second information processing apparatus;
generating a virtual display for displaying an object corresponding to the external data on the display unit;
acquiring a display range of the virtual display in the display unit;
acquiring a user input;
generating instruction information for the second information processing apparatus;
transmitting the instruction information to the second information processing apparatus; and
in a case where the user input for dragging the object to outside the display range has been acquired, generating, as the instruction information, processing which the second information processing apparatus is caused to perform depending on a position to which the object has been dragged.

10. A non-transitory computer-readable storage medium storing instructions that, when executed by one or more processors of an information processing apparatus configured to generate an image to be displayed on an eyewear-type display unit, cause the information processing apparatus to perform an information processing method comprising:
receiving external data which a second information processing apparatus different from the information processing apparatus retains from the second information processing apparatus;
generating a virtual display for displaying an object corresponding to the external data on the display unit;
acquiring a display range of the virtual display in the display unit;
acquiring a user input;
generating instruction information for the second information processing apparatus;
transmitting the instruction information to the second information processing apparatus; and
in a case where the user input for dragging the object to outside the display range has been acquired, generating, as the instruction information, processing which the second information processing apparatus is caused to perform depending on a position to which the object has been dragged.
